(19) United States
(12) Patent Application Publication
(10) Pub. No.: US 2014/0238186 A1
(43) Pub. Date: Aug. 28, 2014

(54) DRIVING APPARATUS FOR HYBRID VEHICLE

(71) Applicant: HYUNDAI MOTOR COMPANY, SEOUL (KR)

(72) Inventors: KYUNG HA KIM, Yongin-si (KR); HEE RA LEE, Anyang-si (KR); YEON HO KIM, Suwon-si (KR); MIN SUNG KIM, Seoul (KR)

(73) Assignee: HYUNDAI MOTOR COMPANY, SEOUL (KR)

(21) Appl. No.: 13/942,469

(22) Filed: Jul. 15, 2013

(30) Foreign Application Priority Data
Feb. 22, 2013 (KR) 10-2013-0019194

(51) Int. Cl. B60K 6/20

(52) U.S. Cl. CPC B60K 6/20; Y10S 903/951
USPC 74/661; 180/65.22; 903/951

(57) ABSTRACT

A driving apparatus for a hybrid vehicle includes an engine, a motor having a stator and a rotor, and a transmission to which a driving force is delivered selectively from the engine, the motor or both the engine and the motor. The motor is provided between the engine and the transmission to transmit the driving force to the transmission. The motor can be an inner rotor-type motor in which the stator is disposed at an outer side of the motor and the rotor is disposed at an inner side of the motor or an outer rotor-type motor in which the stator is disposed at an inner side of the motor and the rotor is disposed at an outer side of the motor.

### CROSS-REFERENCE TO RELATED APPLICATION

The present application claims priority of Korean Patent Application Number 10-2013-0019194 filed Feb. 22, 2013, the entire contents of which application are incorporated herein for all purposes by this reference.

### BACKGROUND OF INVENTION

1. Field of Invention

The present invention relates to a driving apparatus for a hybrid vehicle, and, more specifically, to a driving apparatus for a hybrid vehicle in which a layout of a motor and an engine clutch is improved.

2. Description of Related Art

In general, a hybrid vehicle is driven by an electric motor as well as an internal combustion engine using gasoline, diesel, etc., which synergistically combines the above to improve fuel efficiency, and reduce environmental pollution.

Such a hybrid vehicle uses a clutch device to deliver the drive force from the engine to the transmission, and the clutch device includes a clutch which connects or disconnects the drive force from the engine to or from the transmission, and a torsional damper which absorbs vibration and shock generated in a rotation direction when the clutch is operated.

Referring to FIG. 1, a driving apparatus for a hybrid vehicle according to the related art includes an engine 1, an automatic transmission 2, a clutch device 3 disposed between the engine 1 and the automatic transmission 2, a motor 4, and an oil pump 5.

However, in the driving apparatus according to the related art, the motor 4 and the clutch device 3 are mounted on the shaft which is the input shaft between the engine 1 and the transmission 2, such that a space for mounting the motor 4 and the clutch device 3 is insufficient, and the entire length of the driving apparatus is increased and the apparatus becomes larger.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve at least some of the above-mentioned problems occurring in the prior art while advantages achieved by the prior art are maintained intact.

Various aspects of the present invention provide for a driving apparatus for a hybrid vehicle in which a layout of a motor and a clutch device is improved so that the entire length or size of the driving apparatus is reduced and the motor and the clutch device are easily mounted therein.

In various aspects of the present invention, there is provided a driving apparatus for a hybrid vehicle that may include an engine, a motor having a stator and a rotor, and a transmission to which a driving force is delivered selectively from the engine, the motor or both the engine and the motor, wherein the motor is provided between the engine and the transmission, and is an inner rotor-type motor in which the stator is disposed at an outer side of the motor and the rotor is disposed at an inner side of the motor, to transmit the driving force to the transmission.

In various other aspects of the present invention, there is provided a driving apparatus for a hybrid vehicle that may include an engine, a motor having a stator and a rotor, and a transmission to which a driving force is delivered selectively from the engine, the motor or both the engine and the motor, wherein the motor is provided between the engine and the transmission, and is an outer rotor-type motor in which the stator is disposed at an inner side of the motor and the rotor is disposed at an outer side of the motor, to transmit the driving force to the transmission

The driving apparatus for a hybrid vehicle may further include a position sensor disposed between the motor and an input shaft of the transmission for determining a rotation position of the rotor. Also, the driving apparatus for a hybrid vehicle may further include a cooling water channel that is disposed outside the stator.

The apparatus may further include an engine clutch device disposed between the engine and the transmission, the engine clutch device selectively connecting or disconnecting the engine to or from the transmission.

The engine clutch device may include an engine clutch and a torsional damper. The engine clutch and the torsional damper may be integrated and provided between the motor and the transmission. Or the engine clutch and the torsional damper may be separated from each other, wherein the engine clutch is integrated with a rotation part of the motor and is disposed between the transmission and the motor, and the torsional damper is provided between the engine and the motor.

The driving apparatus for a hybrid vehicle may further include an actuator disposed between the motor and an input shaft of the transmission, wherein the actuator is connected to a hydraulic oil pipe that passes through between the motor and an engine clutch device

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF TILE DRAWINGS

FIG. 1 illustrates a driving apparatus for a hybrid vehicle according to the related art.

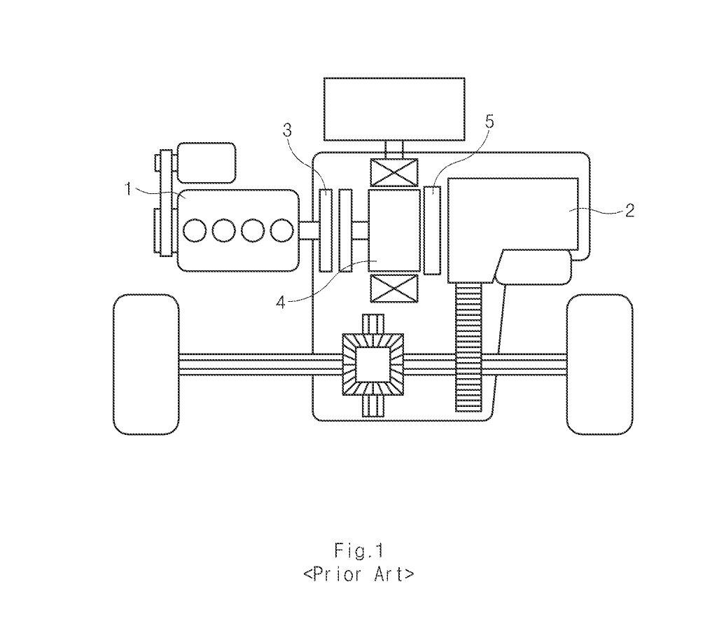

FIG. 2 illustrates an exemplary driving apparatus for a hybrid vehicle according to the present invention; and

FIG. 3 illustrates another driving apparatus for a hybrid vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In a driving apparatus for a hybrid vehicle according to the present invention, a layout of a motor and an engine clutch device is improved.

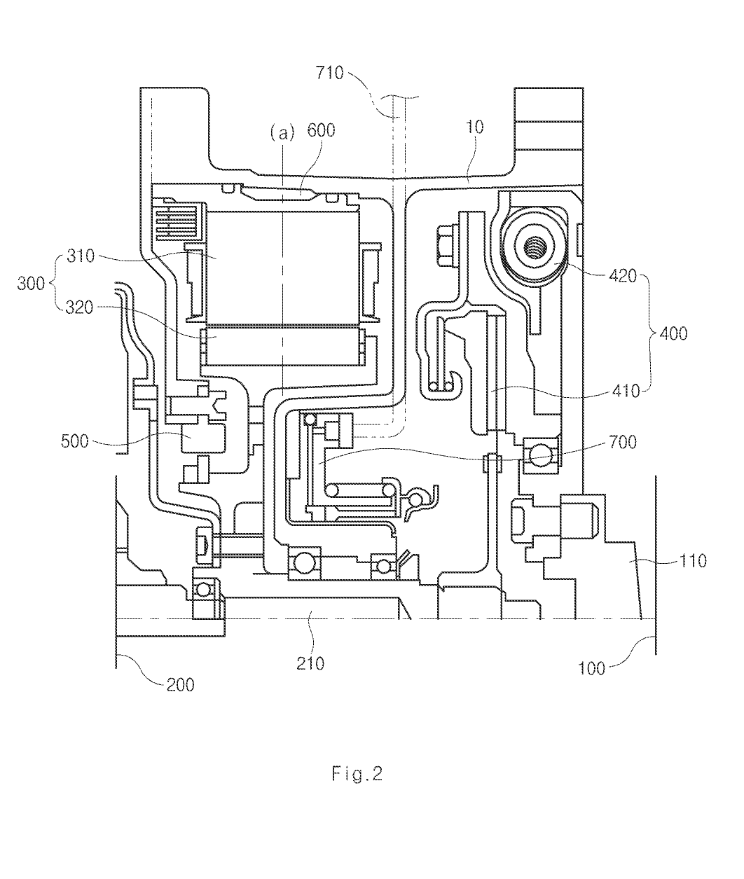

Referring to FIG. 2, a driving apparatus for a hybrid vehicle according to various embodiments of the present invention includes an engine 100, a transmission 200, a motor 300 disposed between the engine 100 and the transmission 200, and an engine clutch device 400. The motor 300 and the engine clutch device 400 are disposed in a housing 10 located between an output shaft 110 of the engine 100 and an input shaft 210 of the transmission 200. The housing 10 rotates together with the output shaft 110.

The engine 100 is an apparatus which generates the driving force, and the transmission 200 is an apparatus which receives the driving force from the engine 100 to change the speed.

The motor 300, in addition to the engine 100, transmits the driving force to the transmission 200, is driven by power supplied from a battery, and includes a stator 310 and a rotor 320. The stator 310 and the rotor 320 of an inner rotor type are provided in the housing 10 between the engine 100 and the transmission 200.

That is, the stator 310 is disposed at the outer side of the motor and the rotor 320 is disposed at the inner side of the motor. Specifically, as seen from FIG. 2, the stator 310 and the rotor 320 are disposed vertically between the engine 100 and the transmission 200, with the stator 310 above the rotor 320, such that the driving force is transmitted to the transmission 200 by the rotor 320.

In other words, the motor 300 comprised of the stator 310 and the rotor 320 of the inner rotor type is disposed between the engine 100 and the transmission 200, such that the entire length from the engine 100 to the transmission 200 may be reduced. As a result, the layout between the engine 100 and the transmission 200 may be improved by the reduced length.

Now, the engine clutch device 400 connects or disconnects the driving force from the engine 100 to or from the transmission 200, and mitigates shock. The engine clutch device 400 includes an engine clutch 410 which connects or disconnects the driving force from the engine 100 to or from the transmission 200, and a torsional damper 420 which absorbs vibration and shock generated in a rotation direction when the engine clutch 410 is operated.

Here, the engine clutch device 400 is disposed between the engine 100 and the transmission 200, in which the engine clutch 410 and the torsional damper 420 are integrated.

That is, since the engine clutch 410 and the torsional damper 420 in the engine clutch device 400 are integrated, the entire length of the engine clutch device 400 may be reduced, such that the layout between the engine 100 and the transmission 300 may be improved by the reduced length.

Further, a position sensor 500 to determine the position of the rotor 320 is provided between the motor 300 and the input shaft 210 of the transmission 200. The position sensor 500 is provided under the rotor 320 as seen from FIG. 2.

That is, the position sensor 500 is positioned near the lower portion of the rotor 320 at line (a) extending in the longitudinal direction of the motor 300 and approximately or substantially equally dividing the motor in the traverse direction, thereby the entire length from the engine 100 to the transmission 200 need not be increased.

Further, at the outside of the stator 310, a cooling water channel 600 to cool the stator 310 is provided in the housing 10, which is positioned at the upper portion of the stator 310 as seen from FIG. 2.

That is, the cooling water channel 600 is positioned near the upper portion of the stator 310 at line (a) extending in the longitudinal direction of the motor 300 and approximately or substantially equally dividing the motor in the traverse direction, thereby the entire length between the engine 100 and the transmission 200 need not be increased.

In addition, an actuator 700 is provided in the housing 10 between the motor 300 and the input shaft 210 of the transmission 200. The actuator 700 is connected to an oil pump via a hydraulic oil pipe 710, along line (a) extending in the longitudinal direction of the motor 300 and approximately or substantially equally dividing the motor in the traverse direction.

The hydraulic oil pipe 710 passes through between the motor 300 and the engine clutch device 400, and thus the layout between the engine 100 and the transmission 200 is minimally increased.

Accordingly, in the driving apparatus for a hybrid vehicle according to various embodiments of the present invention, the motor 300 of an inner rotor type is used, and the engine clutch device 400 of an integrated type is used, such that the layout between the engine 100 and the transmission 200 may be improved and thus the driving apparatus may be easily mounted and scaled down.

Hereinafter, various other embodiments of the present invention will be described, in which the same or similar elements will be denoted by the same or similar reference numerals, and redundant descriptions will be omitted.

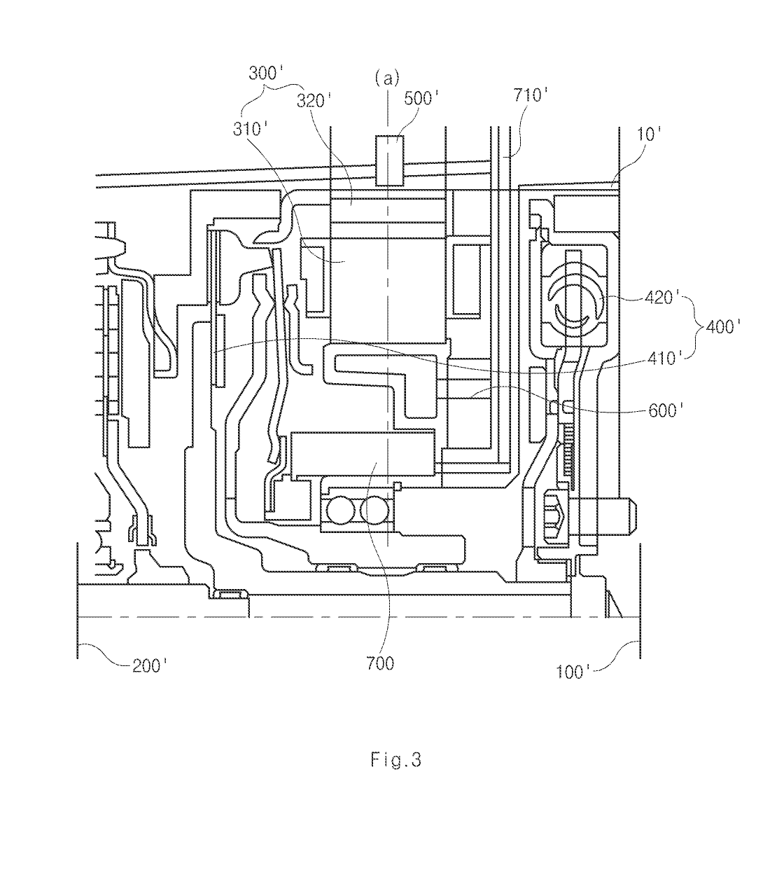

FIG. 3 is a view showing a driving apparatus for a hybrid vehicle according to various other embodiments of the present invention. Referring to FIG. 3, a driving apparatus for a hybrid vehicle of the present invention includes an engine 100′, a transmission 200′, a motor 300′ disposed between the engine 100′ and the transmission 200′, and an engine-clutch apparatus 400′.

Here, the motor 300′ comprises a stator 310′ and a rotor 320′, and the stator 310′ and the rotor 320′ of an outer rotor type are provided in the housing 10′. That is, the stator 310′ is disposed at the inner side of the motor while the rotor 320′ is disposed at the outer side of the motor. More specifically, as seen from FIG. 3, the stator 310′ and the rotor 320′ are provided between the engine 100′ and the transmission 200′, with the stator 310′ below the rotor 320′, thereby transmitting the driving force to the transmission 200′ by the rotor 320′.

The engine clutch device 400′ includes an engine clutch 410′ and a torsional damper 420′ which are separated from each other. That is, the engine clutch 410′ is integrated with a rotating part of the motor 300′ between the transmission 200′ and the motor 300′, and the torsional damper 420′ is provided between the engine 100′ and the motor 300′

That is, the structure of the engine clutch device 400′ may be simplified by integrating the engine clutch 410′ with the rotation part of the motor 300′, thereby minimizing the entire length from the engine 100′ to the transmission 200′ and thus improving the layout between the engine 100′ and the transmission 200′.

In addition, a position sensor 500′ or a cooling water channel 600′ may be provided along line (a) extending in the longitudinal direction of the motor 300′ and approximately or substantially equally dividing the motor 300′ in the traverse direction.

That is, the position sensor 500′ is positioned at the upper portion of the rotor 320′ as seen from FIG. 3, and the cooling water channel 600′ is positioned at the lower portion of the stator 310′ as seen from FIG. 3, whereby the entire length from the engine 100 to the transmission 200 need not be increased.

As stated above, according to the present invention, a layout of a motor and a clutch device in a driving apparatus for a hybrid vehicle is improved so that the entire length of the driving apparatus can be reduced and the motor and the clutch device can be easily mounted therein.

For convenience in explanation and accurate definition in the appended claims, the terms “upper” or “lower”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A driving apparatus for a hybrid vehicle, comprising:
an engine;
a motor having a stator and a rotor; and
a transmission to which a driving force is delivered selectively from the engine, the motor or both the engine and the motor,
wherein the motor is provided between the engine and the transmission, and is an inner rotor-type motor in which the stator is disposed at an outer side of the motor and the rotor is disposed at an inner side of the motor, to transmit the driving force to the transmission.

2. A driving apparatus for a hybrid vehicle, comprising:
an engine;
a motor having a stator and a rotor; and
a transmission to which a driving force is delivered selectively from the engine, the motor or both the engine and the motor,
wherein the motor is provided between the engine and the transmission, and is an outer rotor-type motor in which the stator is disposed at an inner side of the motor and the rotor is disposed at an outer side of the motor, to transmit the driving force to the transmission.

3. The apparatus according to claim 1, further comprising a position sensor disposed between the motor and an input shaft of the transmission for determining a rotation position of the rotor.

4. The apparatus according to claim 2, further comprising a position sensor disposed between the motor and an input shaft of the transmission for determining a rotation position of the rotor.

5. The apparatus according to claim 1, further comprising a cooling water channel that is disposed outside the stator.

6. The apparatus according to claim 2, further comprising a cooling water channel that is disposed outside the stator.

7. The apparatus according to claim 1, further comprising an engine clutch device disposed between the engine and the transmission, the engine clutch device selectively connecting or disconnecting the engine to or from the transmission.

8. The apparatus according to claim 7, wherein the engine clutch device comprises an engine clutch and a torsional damper that are integrated and are provided between the motor and the transmission.

9. The apparatus according to claim 7, wherein the engine clutch device comprises an engine clutch and a torsional damper that are separated from each other, wherein the engine clutch is integrated with a rotation part of the motor and is disposed between the transmission and the motor, and the torsional damper is provided between the engine and the motor.

10. The apparatus according to claim 2, further comprising an engine clutch device disposed between the engine and the transmission, the engine clutch device selectively connecting or disconnecting the engine to or from the transmission.

11. The apparatus according to claim 10, wherein the engine clutch device comprises an engine clutch and a torsional damper that are integrated and are provided between the motor and the transmission.

12. The apparatus according to claim 10, wherein the engine clutch device comprises an engine clutch and a torsional damper that are separated from each other, wherein the engine clutch is integrated with a rotation part of the motor and is disposed between the transmission and the motor, and the torsional damper is provided between the engine and the motor.

13. The apparatus according to claim 1, further comprising an actuator disposed between the motor and an input shaft of the transmission, wherein the actuator is connected to a hydraulic oil pipe that passes through between the motor and an engine clutch device.

14. The apparatus according to claim 2, further comprising an actuator disposed between the motor and an input shaft of the transmission, wherein the actuator is connected to a hydraulic oil pipe that passes through between the motor and an engine clutch device.
